(19) United States
(12) Patent Application Publication
(10) Pub. No.: US 2016/0364069 A1
(43) Pub. Date: Dec. 15, 2016

(54) TOUCH DISPLAY DEVICE

(71) Applicant: InnoLux Corporation, Miao-Li County (TW)

(72) Inventors: Chu-Hung TSAI, Miao-Li County (TW); Hung-Kun CHEN, Miao-Li County (TW); Yu-Chien KAO, Miao-Li County (TW); Chia-Hsiung CHANG, Miao-Li County (TW); Jen-Chieh PENG, Miao-Li County (TW); Chia-Hao TSAI, Miao-Li County (TW); Chih-Hao CHANG, Miao-Li County (TW); Bo-Feng CHEN, Miao-Li County (TW); Tung-Kai LIU, Miao-Li County (TW)

(21) Appl. No.: 15/174,794

(22) Filed: Jun. 6, 2016

Related U.S. Application Data
(60) Provisional application No. 62/193,787, filed on Jul. 17, 2015.
(60) Provisional application No. 62/174,728, filed on Jun. 12, 2015.

(30) Foreign Application Priority Data
Dec. 3, 2015 (TW) 104140489

(51) Int. Cl. G06F 3/041

(52) U.S. Cl. CPC G06F 3/0416; G06F 3/0412

(57) ABSTRACT

A touch display device including a first substrate, a second substrate, and a display medium is provided. The first substrate includes a plurality of pixel units, a first touch electrode, and a plurality of first connection lines. The pixel units are arranged in an array. The first touch electrode corresponds to at least one pixel unit. The first connection lines are extended along a first direction and coupled between the first touch electrode and a touch integrated circuit. The display medium is disposed between the first and second substrates.

### CROSS REFERENCE TO RELATED APPLICATIONS

This application claims the benefit of U.S. Provisional Application No. 62/174,728, filed Jun. 12, 2015, and U.S. Provisional Application No. 62/193,787, filed Jul. 17, 2015, which applications are hereby incorporated by reference in the entirety.

This Application claims priority of Taiwan Patent Application No. 104140489, filed on Dec. 3, 2015, the entirety of which is incorporated by reference herein.

### BACKGROUND OF THE INVENTION

Field of the Invention

The disclosure relates to a display device, and more particularly to a display device with touch function.

Description of the Related Art

Liquid-crystal displays (LCDs) are widely used as they possess the favorable advantages of having a thin profile and low radiation, and being lightweight. Current display devices have touch functionality. However, the length of transmission lines used in transmitting signals increases incrementally as the size of the display device increases. Since long transmission lines have high resistance, the accuracy of signals transmitted by these transmission lines can be altered by the resistance of the transmission lines.

### BRIEF SUMMARY OF THE INVENTION

In accordance with an embodiment, a touch display device comprises a first substrate, a second substrate, and a display medium. The first substrate comprises a plurality of pixel units, a first touch electrode, and a plurality of first connection lines. The pixel units are arranged in an array. The first touch electrode corresponds to at least one pixel unit. The first connection lines are extended along a first direction and coupled between the first touch electrode and a touch integrated circuit. The display medium is disposed between the first and second substrates.

A detailed description is given in the following embodiments with reference to the accompanying drawings.

### BRIEF DESCRIPTION OF THE DRAWINGS

The disclosure can be more fully understood by referring to the following detailed description and examples with references made to the accompanying drawings, wherein:

FIG. 1 is a cross sectional view of a touch display device;

FIGS. 2˜3, 4A˜4D, 5A˜5B, and 6˜8 are schematic diagrams of exemplary embodiments of a touch element layer, according to various aspects of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

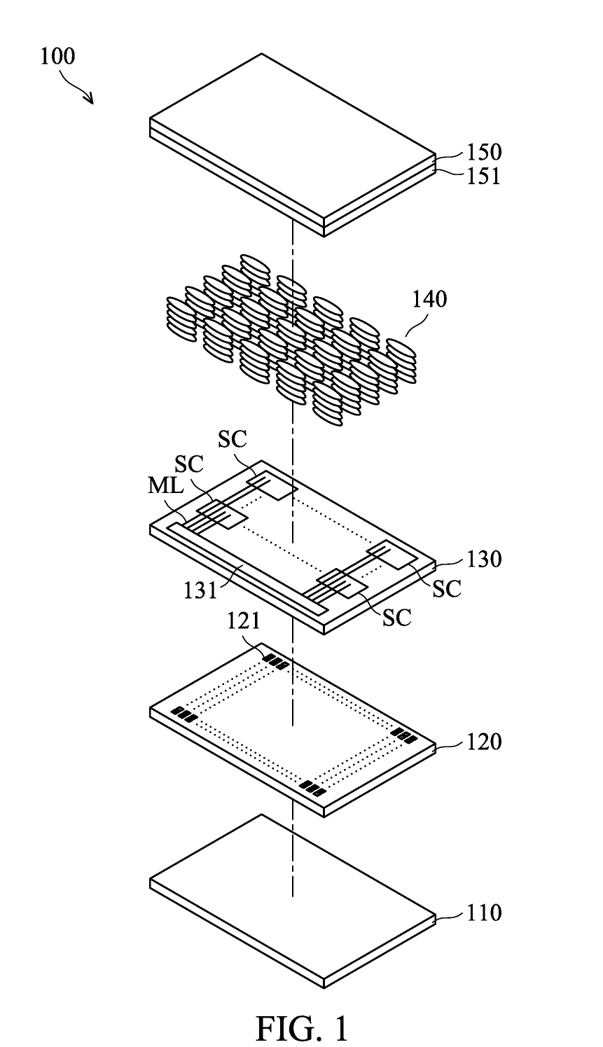

FIG. 1 is a cross sectional view of a touch display device. As shown in FIG. 1, the touch display device 100 at least comprises a first substrate 110, a display element layer 120, a touch element layer 130, a display medium layer 140, and a second substrate 150. The display element layer 120 is formed on the first substrate 110. In one embodiment, the display element layer 120 comprises at least one metal layer (not shown) to form a plurality of pixel units 121. The pixel units 121 may be arranged in an array, but the disclosure is not limited thereto. In other embodiments, the pixel units 121 may be arranged according to a delta method.

The touch element layer 130 is disposed on the display element layer 120, but the disclosure is not limited thereto. In some embodiments, the touch element layer 130 is disposed between the display element layer 120 and the first substrate 110. When the touch element layer 130 is disposed on the display element layer 120, the position relationship between the display element layer 120 and the touch element layer 130 is referred to as a top-com structure. When the display element layer 120 is disposed on the touch element layer 130, the position relationship between the display element layer 120 and the touch element layer 130 is referred to as a top-pixel structure.

The touch element layer 130 may comprise at least one metal layer to form a plurality of touch electrodes SC and connection lines ML connecting to the touch electrodes SC. In a touch sensing mode, the touch electrodes SC receive sensing signals provided from a touch integrated circuit (IC) 131 via the connection lines ML. The touch IC 131 detects the electrical variations in the touch electrodes SC via the connection lines ML to determine whether the touch display device 100 is touched by a user. In a display mode, the touch electrodes SC receive common voltage and serve as the common electrodes.

The display medium layer 140 is disposed between the touch element layer 130 and the second substrate 150. The display medium of the display medium layer 140 may be liquid crystal or organic light-emitting diodes. In this embodiment, since the touch element layer 130 is disposed between the display medium layer 140 and the first substrate 110, the touch display device 100 is referred to as an in-cell structure.

The second substrate 150 comprises a color filter layer 151. The color filter layer 151 comprises a plurality of color filters to pass through lights with specific colors. In one embodiment, each color filter corresponds to one of the pixel units 121. In another embodiment, the second substrate 150 may not comprise the color filter layer 151. In some embodiments, the first substrate 110 comprises the color filter layer 151.

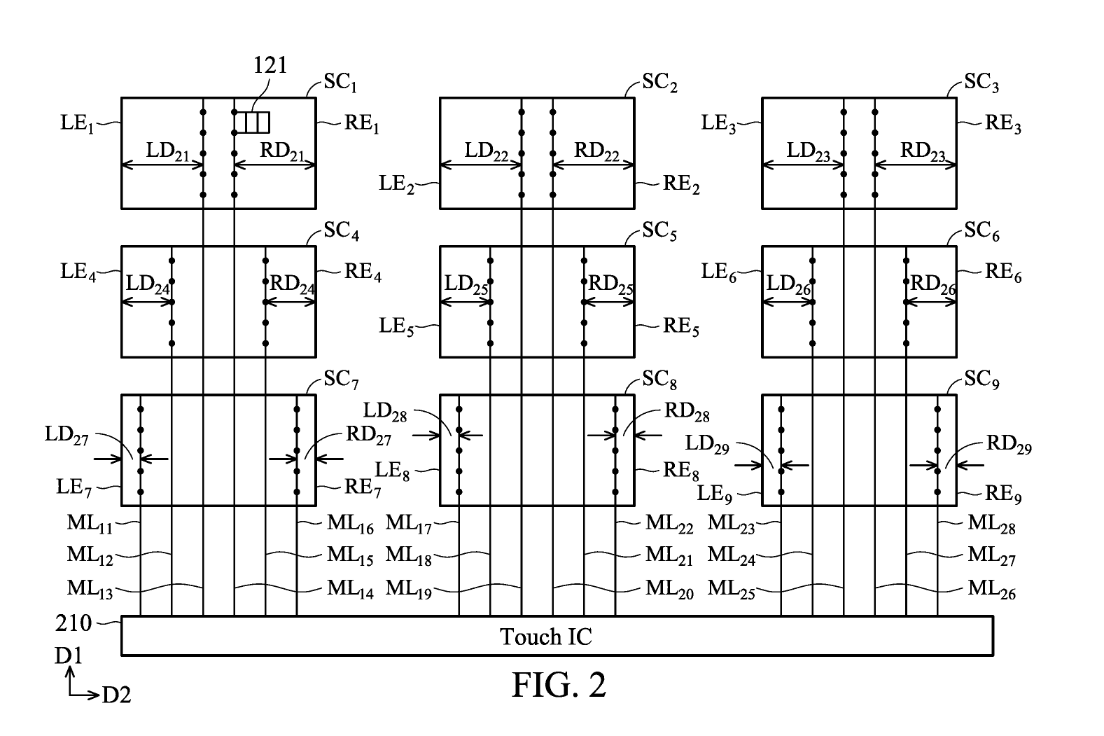

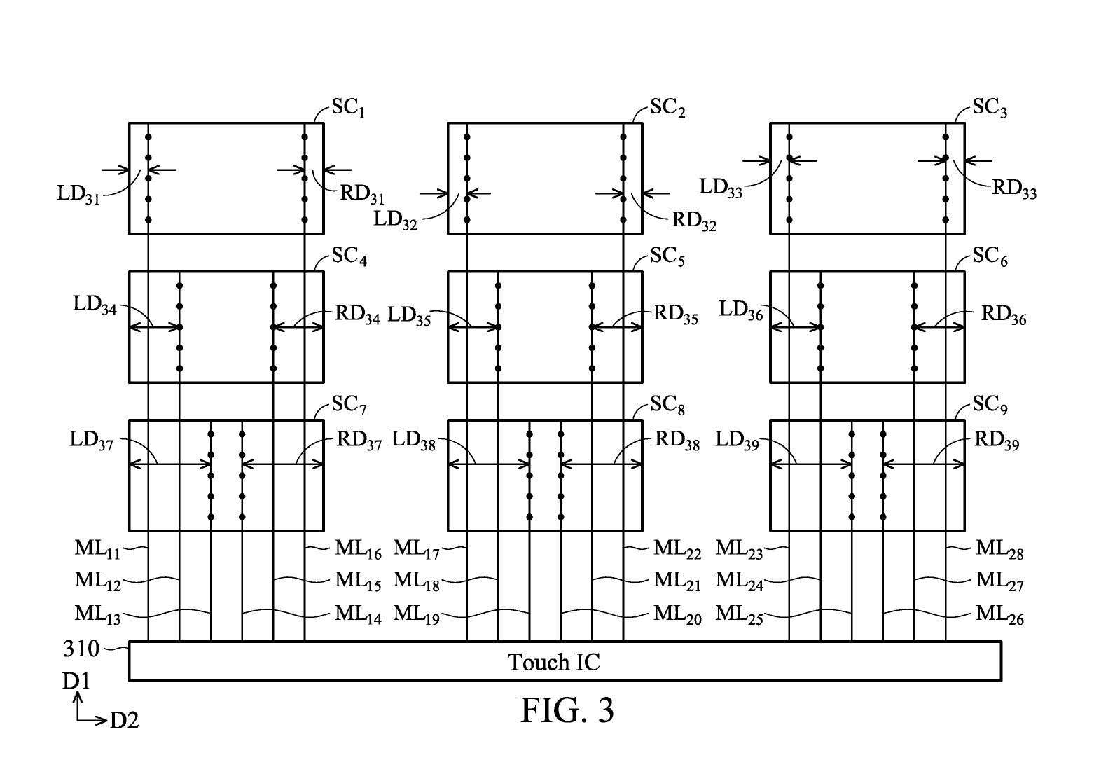

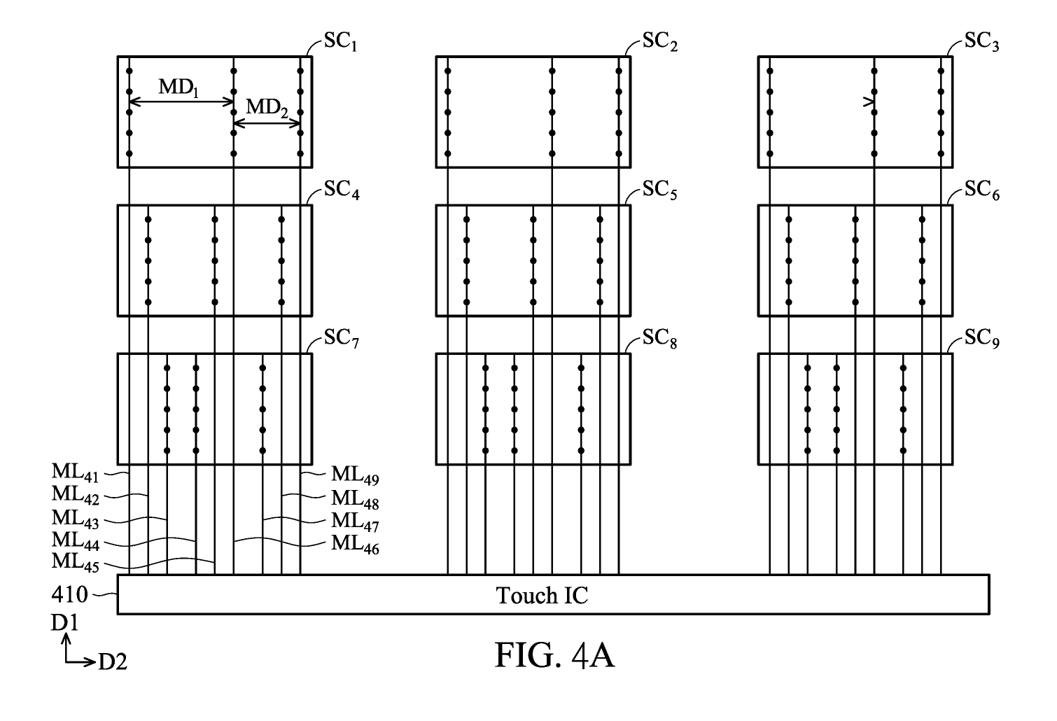

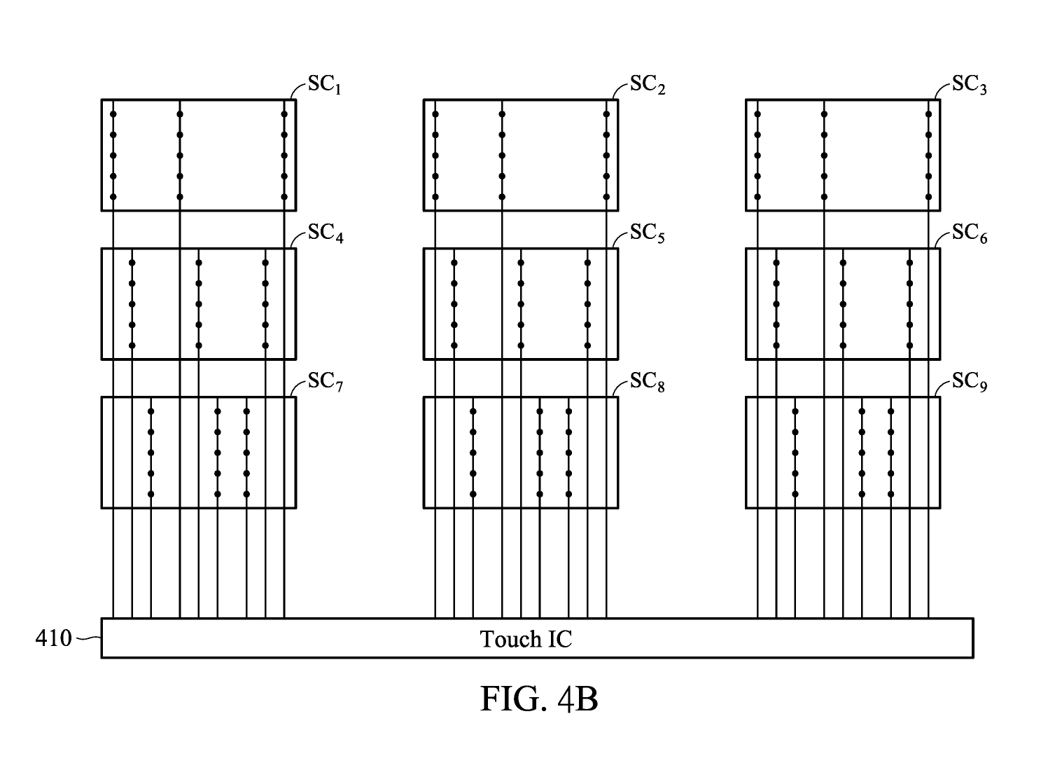

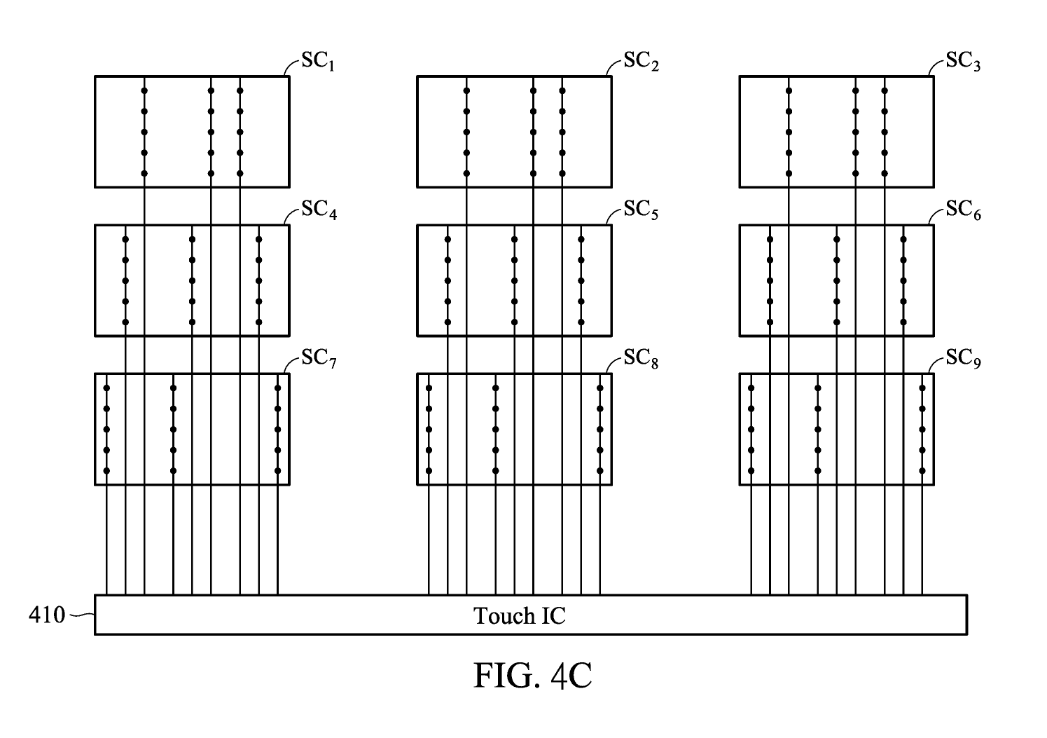

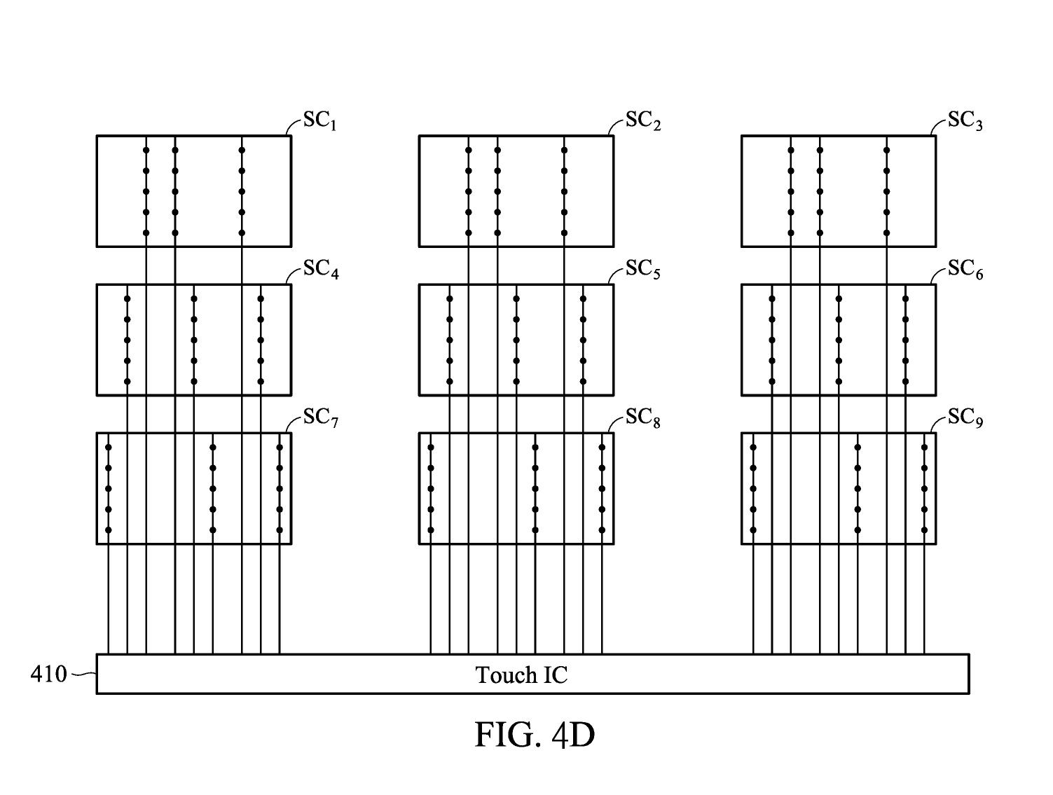

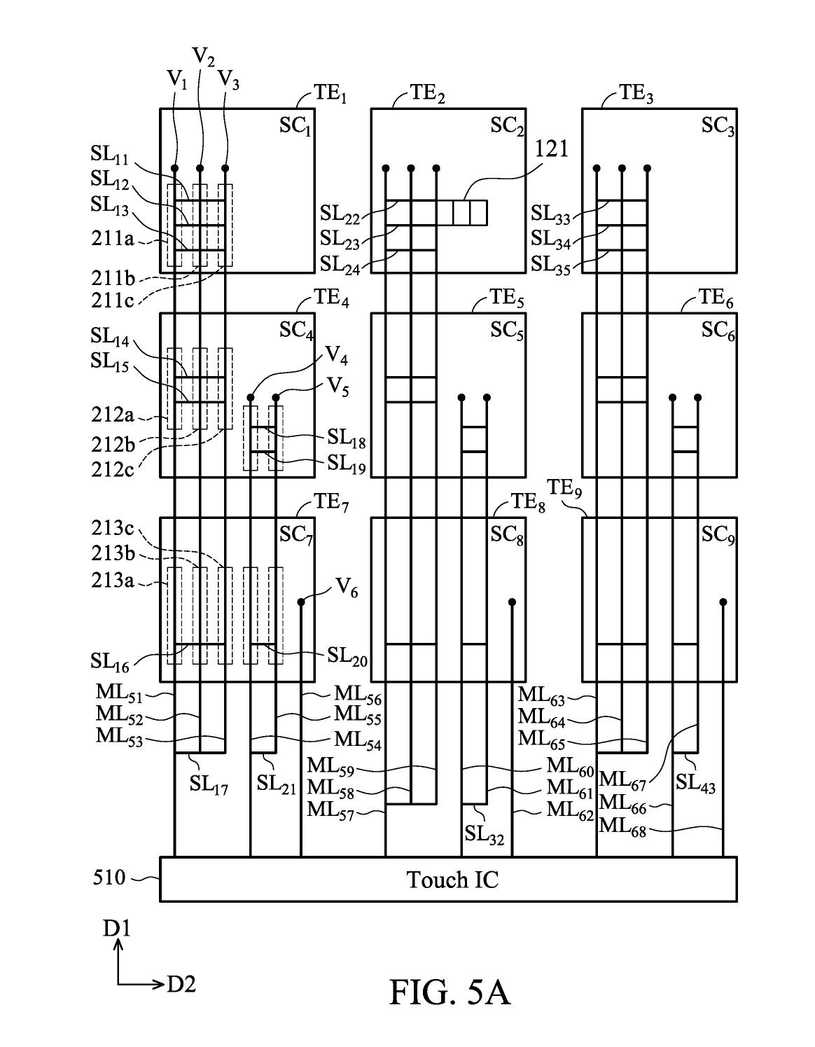

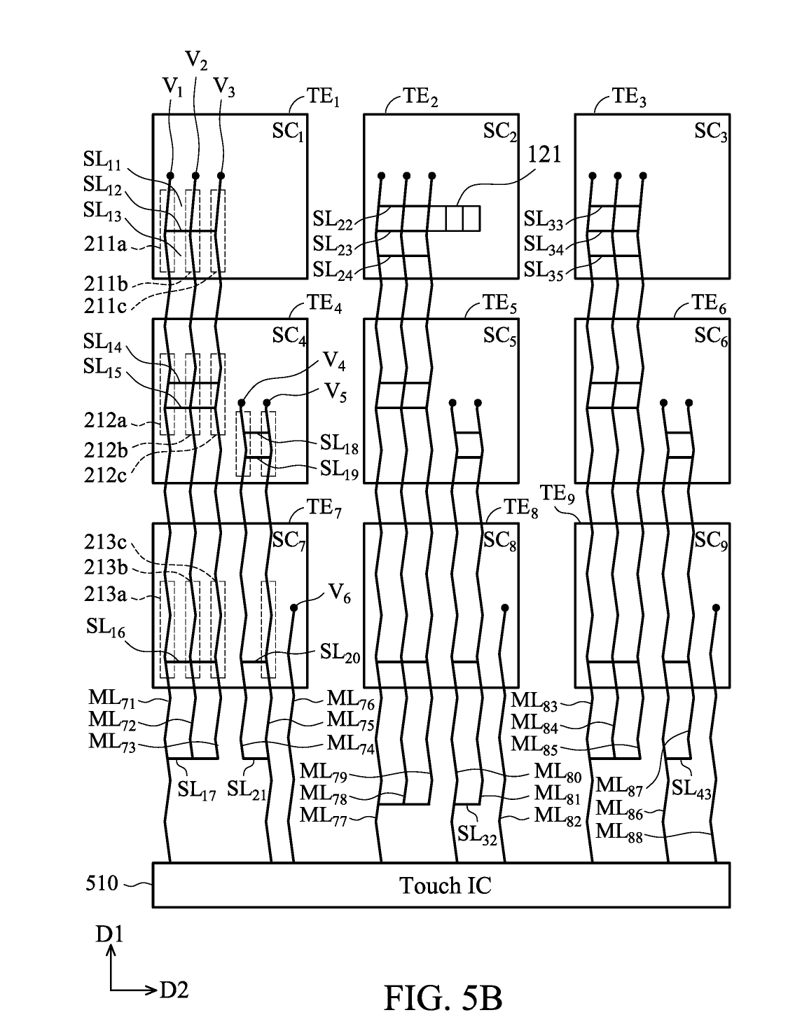

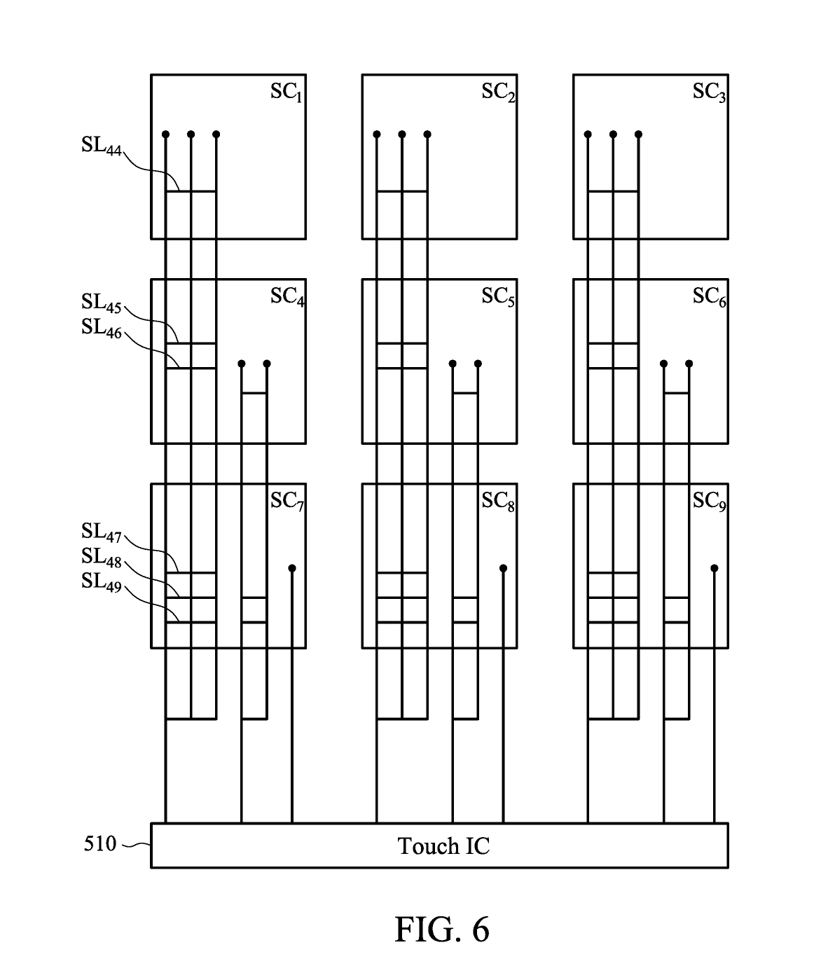

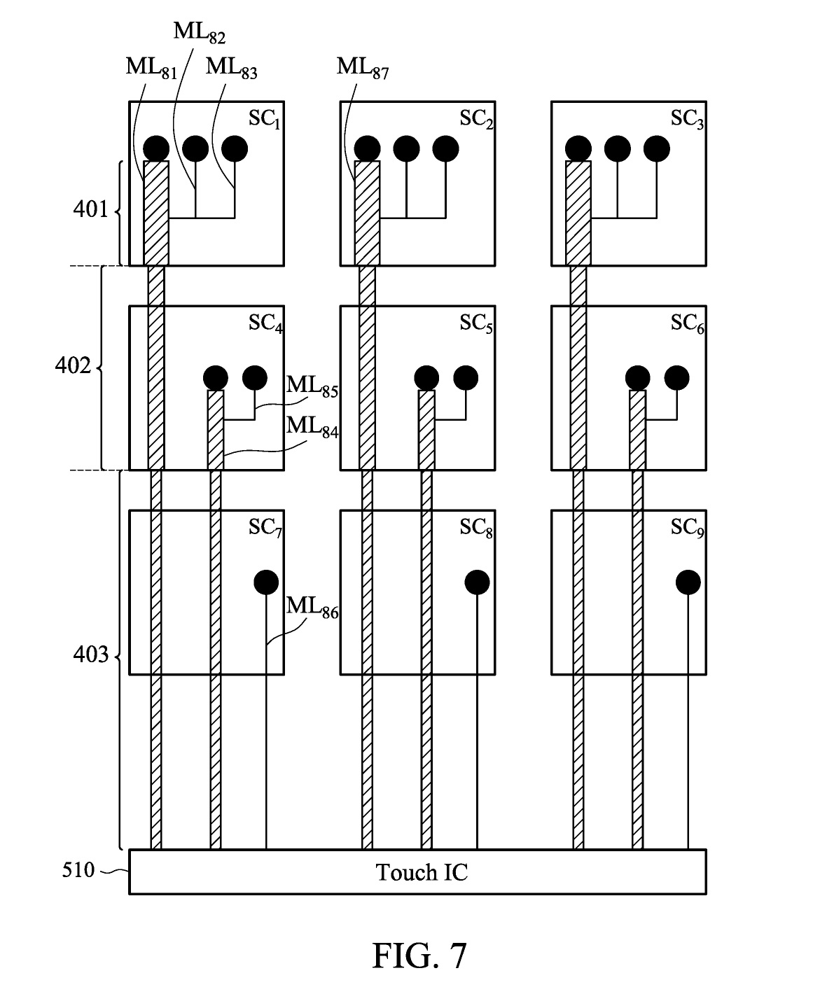

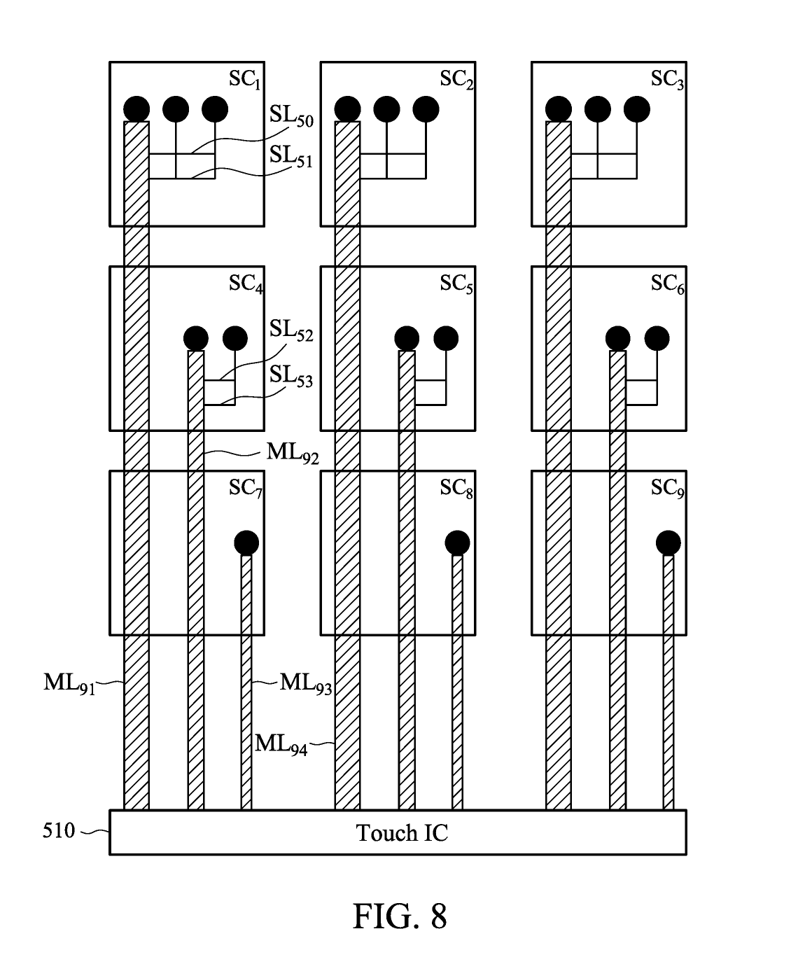

FIG. 2 is a schematic diagram of an exemplary embodiment of the touch element layer 130, according to various aspects of the present disclosure. The touch element layer 130 at least comprises a plurality of touch electrodes, and the touch electrodes are coupled to a touch IC. For brevity, FIG. 2 only shows the touch electrodes SC₁˜SC₉, but the disclosure is not limited thereto. In some embodiments, the touch element layer 130 may comprise any suitable number of touch electrodes. Each touch electrode corresponds to at least one of the pixel units 121. The disclosure does not limit the arrangement of the touch electrodes SC₁˜SC₉. In one embodiment, the touch electrodes SC₁˜SC₉ are arranged in an array.

The touch electrodes SC₁˜SC₉ are coupled to the touch IC 210 via the connection lines ML₁₁˜ML₂₈. The connection lines ML₁₁˜ML₂₈ are extended along a first direction D1. In a touch sensing mode, the touch IC 210 provides sensing signals to the touch electrodes SC₁˜SC₉ via the connection lines ML₁₁˜ML₂₈ and detects the electrical variations of the touch electrodes SC₁˜SC₉ to determine the touched position on the touch display device 100. In a display mode, the touch electrodes SC₁˜SC₉ serve as common electrodes and receive common voltage.

In this embodiment, since the connection lines ML₁₁˜ML₂₈ are separated from each other, the touch IC 210 can provide different sensing signals to the same touch electrode. For example, the touch IC 210 provides a first sensing signal to the touch electrode SC₁ via the connection line ML₁₃ and provides a second sensing signal to the touch electrode SC₁ via the connection line ML₁₄. The first sensing signal may be the same as or different from the second sensing signal. In this case, since the touch IC 210 provides two sensing signals to the different regions of the touch electrode SC₁ via the independent connection lines ML₁₃ and ML₁₄, the touch IC 210 can control the voltage levels of the different regions of the touch electrode SC₁.

In this embodiment, each touch electrode is coupled to the touch IC 210 via a plurality of connection lines. For example, the touch electrode SC₁ is coupled to the touch IC 210 via the connection lines ML₁₃ and ML₁₄, the touch electrode SC₄ is coupled to the touch IC 210 via the connection lines ML₁₂ and ML₁₅, and the touch electrode SC₇ is coupled to the touch IC 210 via the connection lines ML₁₁ and ML₁₆. The disclosure does not limit the number of connection lines connecting to the same touch electrode. In some embodiments, at least one of the touch electrodes SC₁˜SC₉ is coupled to two or more connection lines.

Additionally, in this embodiment, each touch electrode is coupled to two connection lines, but the disclosure is not limited thereto. In some embodiments, the number of connection lines connecting to at least one of the touch electrodes SC₁˜SC₉ is different from the number of connection lines connecting to another of the touch electrodes SC₁˜SC₉. For example, the touch electrode SC₁ may be coupled to three connection lines, and the touch electrode SC₄ may be coupled to two connection lines.

In this embodiment, each of the touch electrodes SC₁˜SC₉ is coupled to the corresponding connection lines via five through holes, but the disclosure is not limited thereto. In one embodiment, the number of through holes coupled to at least one of the touch electrodes SC₁˜SC₉ is different from the number of through holes coupled to another of the touch electrodes SC₁˜SC₉. In another embodiment, each of the touch electrodes SC₁˜SC₉ may couple to the corresponding connection lines via any suitable number of the through holes.

Each touch electrode is electrically connected to two connection lines. In this embodiment, the connection line close to the left edge of the touch electrode is referred to as a left connection line, and the connection line close to the right edge of the touch electrode is referred to as a right connection line. For example, the connection line ML₁₃ coupled to the touch electrode SC₁ is close to the left edge LE₁ of the touch electrode SC₁ such that connection line ML₁₃ is referred to as a left connection line. Similarly, the connection line ML₁₄ coupled to the touch electrode SC₁ is close to the right edge RE₁ of the touch electrode SC₁ such that connection line ML₁₄ is referred to as a right connection line.

The distance between the left connection line of each touch electrode and the corresponding left-edge is referred to as a left distance. The distance between the right connection line of each touch electrode and the corresponding right-edge is referred to as a right distance. For example, the distance LD₂₁ between the left connection line ML₁₃ of the touch electrode SC₁ and the left-side LE₁ is extended along a second direction D2 and referred to as a left distance. In one embodiment, the second direction D2 is vertical to the first direction D1. The distance RD₂₁ between the right connection line ML₁₄ of the touch electrode SC₁ and the right-side RE₁ is extended along the second direction D2 and referred to as a right distance.

For the same touch electrode, the left distance may be equal to or unequal to the right distance. Taking the touch electrode SC₁ as an example, the left distance LD₂₁ is equal to the right distance RD₂₁, but the disclosure is not limited thereto. In another embodiment, the left distance LD₂₁ is less than or higher than the right distance RD₂₁. In some embodiments, at least one of the left distances LD₂₁˜LD₂₉ may be equal to or unequal to another of the left distances LD₂₁˜LD₂₉. Similarly, at least one of the right distances RD₂₁˜RD₂₉ may be equal to or unequal to another of the right distances RD₂₁˜RD₂₉.

In this embodiment, the left distance LD₂₂ of the touch electrode SC₂ is equal to the right distance RD₂₁ of the touch electrode SC₁, and the right distance RD₂₂ of the touch electrode SC₂ is equal to the left distance LD₂₃ of the touch electrode SC₃. Similarly, the left distance LD₂₅ of the touch electrode SC₅ is equal to the right distance RD₂₄ of the touch electrode SC₄, and the right distance RD₂₅ of the touch electrode SC₅ is equal to the left distance LD₂₆ of the touch electrode SC₆. The left distance LD₂₈ of the touch electrode SC₈ is equal to the right distance RD₂₇ of the touch electrode SC₇, and the right distance RD₂₈ of the touch electrode SC₈ is equal to the left distance LD₂₉ of the touch electrode SC₉. In this case, the left distance LD₂₅ of the touch electrode SC₅ may be equal to or unequal to the right distance RD₂₅ of the touch electrode SC₅. The left distance LD₂₈ of the touch electrode SC₈ may be equal to or unequal to the right distance RD₂₈ of the touch electrode SC₈.

FIG. 3 is a schematic diagram of an exemplary embodiment of the connection lines and the touch electrodes, according to various aspects of the present disclosure. As shown in FIG. 3, the left distance LD₃₄ of the touch electrode SC₄ is larger than the left distance LD₃₁ of the touch electrode SC₁ and smaller than the left distance LD₃₇ of the touch electrode SC₇. Furthermore, the right distance RD₃₄ of the touch electrode SC₄ is larger than the right distance RD₃₁ of the touch electrode SC₁ and smaller than the right distance RD₃₇ of the touch electrode SC₇.

In this embodiment, the left distance LD₃₂ of the touch electrode SC₂ is equal to the right distance RD₃₁ of the touch electrode SC₁, and the right distance RD₃₂ of the touch electrode SC₂ is equal to the left distance LD₃₃ of the touch electrode SC₃. Similarly, the left distance LD₃₅ of the touch electrode SC₅ is equal to the right distance RD₃₄ of the touch electrode SC₄, and the right distance RD₃₅ of the touch electrode SC₅ is equal to the left distance LD₃₆ of the touch electrode SC₆. The left distance LD₃₈ of the touch electrode SC₈ is equal to the right distance RD₃₇ of the touch electrode SC₇, and the right distance RD₃₈ of the touch electrode SC₈ is equal to the left distance LD₃₉ of the touch electrode SC₉.

FIGS. 4A˜4D are schematic diagrams of exemplary embodiments of the touch element layer 130, according to various aspects of the present disclosure. In FIGS. 4A˜4D, a middle connection line is disposed between the left connection line and the right connection line for each touch electrode. Taking the touch electrode SC₁ shown in FIG. 4A as an example, the middle connection line ML₄₆ is disposed between the left connection line ML₄₁ and the right connection line ML₄₉.

The disclosure does not limit the distances between the middle connection line and the right connection line and between the middle connection line and the left connection line. Taking the touch electrode SC₁ shown in FIG. 4A as an example, the middle distance MD₁ in the second direction D2 and between the middle connection line ML₄₆ and the left connection line ML₄₁ may be equal to, higher than or smaller than the middle distance MD₂ in the second direction D2 and between the middle connection line ML₄₆ and the right connection line ML₄₉.

FIG. 5A is a schematic diagram of another exemplary embodiment of the touch element layer 130, according to various aspects of the present disclosure. In this embodiment, each touch electrode is coupled to a plurality of connection lines, but only one connection line is directly connected to the touch IC 510. Taking the touch electrode SC₁ as an example, the touch electrode SC₁ is electrically connected to the connection lines ML₅₁˜ML₅₃, and only the connection line ML₅₁ is directly connected to the touch IC 510 and the connection lines ML₅₂˜M₅₃ do not directly connect to the touch IC 510. In this case, the connection lines ML₅₂˜ML₅₃ are electrically connected to the connection line ML₅₁ via the sub-conduction lines SL₁₁˜SL₁₇.

In FIG. 5A, each touch electrode is coupled to a connection line via a through hole. For example, the touch electrode SC₁ is coupled to connection lines ML₅₁˜ML₅₃ via through holes V₁˜V₃, the touch electrode SC₄ is coupled to connection lines ML₅₄˜ML₅₅ via through holes V₄˜V₅, and the touch electrode SC₇ is coupled to connection line ML₅₆ via through hole V₆. The disclosure does not limit the numbers and the positions of the connection lines and the through holes connecting to the same touch electrode. In this embodiment, the numbers of the connection lines and the through holes for the touch electrode SC₁ are different from the numbers of the connection lines and the through holes for another touch electrode (e.g. SC₄ or SC₇), which with the touch electrode SC₁ are arranged in the same column (vertical direction), but the disclosure is not limited thereto. In other embodiments, for the touch electrodes arranged into the same column, the numbers of the connection lines and the through holes of one of the touch electrodes may be equal to the numbers of the connection lines and the through holes of another of the touch electrodes.

Furthermore, in this embodiment, the numbers of the connection lines connecting to the touch electrodes arranged in the same row (horizontal direction) are the same. For example, each of the touch electrodes SC₁˜SC₃ is coupled to three connection lines, but the disclosure is not limited thereto. In some embodiments, for the touch electrodes arranged in the same row, the number of connection lines connecting to one of the touch electrodes may be the same as or different from the number of connection lines connecting to another of the touch electrodes.

For brevity, FIG. 5A only shows connection lines ML₅₁˜ML₆₈. As shown in FIG. 5A, the connection lines ML₅₁˜ML₆₈ are parallel with each other and extended along the first direction D1 (vertical direction). In this embodiment, the connection lines ML₅₁˜ML₆₈ are straight extended, but the disclosure is not limited thereto. In other embodiments, the connection lines ML₇₁˜ML₈₈ are zigzag extended as shown in FIG. 5B.

Refer to FIG. 5A, when the connection lines ML₅₁˜ML₆₈ are extended along the first direction D1, each of the connection lines ML₅₁˜ML₆₈ overlaps at least one touch electrode. For example, the segments 211a˜211c of the connection lines ML₅₁˜ML₅₃ overlap the touch electrode SC₁, the segments 212a˜212c of the connection lines ML₅₁˜ML₅₃ overlap the touch electrode SC₄, and the segments 213a˜213c of the connection lines ML₅₁˜ML₅₃ overlap the touch electrode SC₇.

In one embodiment, the connection lines ML₅₁˜ML₆₈ are extended along the first direction D1 to the top-edge TE₁ of the touch electrode SC₁. In addition, the connection lines ML₅₄˜ML₅₅ can be extended along the first direction D1 to the top-edge TE₄ of the touch electrode SC₄. In this case, the connection lines ML₅₄˜ML₅₅ may be extended along the first direction D1 to the top-edge TE₁ of the touch electrode SC₁. Therefore, the connection lines ML₅₄˜M₅₅ overlap the touch electrode SC₁ and do not electrically connect to the touch electrode SC₁. Similarly, the connection line ML₅₆ can be extended along the first direction D1 to the top-edge TE₇ of the touch electrode SC₇ or more extended to the top-edge TE₄ of the touch electrode SC₄ or more extended to the top-edge TE₁ of the touch electrode SC₁. In this case, the connection line ML₅₆ may overlap the touch electrodes SC₁ and SC₄, and does not electrically connect to the touch electrodes SC₁ and SC₄.

In this embodiment, for the same connection line, the widths of all segments are the same. For example, the widths of the segments 211a˜213a are the same, but the disclosure is not limited thereto. In some embodiments, for the same connection line, the widths of all segments are not the same. Refer to FIG. 7, for the connection line ML₈₁, the widths of the segments 401˜403 are not the same. As shown in FIG. 7, the width of the segment 401 is higher than the width of each of the segments 402 and 403, and the width of the segment 402 is higher than the width of the segment 403. In one embodiment, with increase of distance between the segments and the touch IC 510, the width of the segment is increased, but the disclosure is not limited thereto. In other embodiments, for various segments of the same connection line, the width of at least one of the segments may be the same as the width of another of the segments.

Additionally, for the various connection lines connecting to the same touch electrode, the width of one of the connection lines may be the same as or different from the width of another of the connection lines. Refer to FIG. 7, for the connection lines ML₈₁˜ML₈₃ connecting to the touch electrode SC₁, the width of the connection line ML₈₁ may be different from the width of each of the connection lines ML₈₂ and ML₈₃. In FIG. 7, the width of the connection line ML₈₂ is the same as the width of the connection line ML₈₃, but the disclosure is not limited thereto. In other embodiments, the widths of the various connection lines connecting to the same touch electrode are different.

In other embodiments, the width of one of the connection lines connecting to a touch electrode may be different from the width of one of the connection lines connecting to another touch electrode. Refer to FIG. 7, the width of the connection line ML₈₁ connecting to the touch electrode SC₁ is different from the width of the connection line ML₈₄ connecting to the touch electrode SC₄. In FIG. 7, although the width of the connection line ML₈₁ connecting to the touch electrode SC₁ is the same as the width of the connection line ML₈₇ connecting to the touch electrode SC₂, but the disclosure is not limited thereto. In some embodiments, for the touch electrodes arranged in the same column, the width of one of the connection lines connecting to a touch electrode may be the same as or different from the width of one of the connection lines connecting to another touch electrode. Furthermore, in FIG. 8, the width of the connection line ML₉₁ connecting to the touch electrode SC₁ is fixed and different from the width of the connection line ML₉₂ connecting to the touch electrode SC₄. With increase of distance between the connection lines connecting to the touch electrodes and the touch IC 510, the width of the connection line is increased, but the disclosure is not limited thereto.

Refer to FIG. 5A, the sub-conduction lines SL₁₁˜SL₄₃ are parallel with each other and extended along the second direction D2 (horizontal direction). In one embodiment, the second direction D2 is vertical to the first direction D1. Each sub-conduction line is coupled to at least two neighboring connection lines. For example, the sub-conduction line SL₂₂ is coupled to the connection lines ML₅₇˜ML₅₉, but the disclosure is not limited thereto. In other embodiments, the sub-conduction line SL₂₂ is only coupled to the connection lines ML₅₇ and ML₅₈ or ML₅₈ and ML₅₉. In this embodiment, the sub-conduction lines SL₂₂˜SL₂₄ are coupled to the connection lines ML₅₇˜ML₅₉. In another embodiment, the sub-conduction line SL₂₂ is coupled to the connection lines ML₅₇ and ML₅₈, the sub-conduction line SL₂₃ is coupled to the connection lines ML₅₈ and ML₅₉, and the sub-conduction line SL₂₄ is coupled to the connection lines ML₅₇˜ML₅₉.

For the sub-conduction lines connecting to the same touch electrode, the sub-conduction lines can be divided into a plurality of group. For example, the sub-conduction lines SL₁₁˜SL₁₆ connecting to the touch electrode SC₁ can be divided into a first group, a second group, and a third group. The sub-conduction lines (e.g. SL₁₁˜SL₁₃) of the first group are coupled to the segments 211a˜211c of the connection lines ML₅₁˜ML₅₃. The sub-conduction lines (e.g. SL₁₄˜SL₁₅) of the second group are coupled to the segments 212a˜212c of the connection lines ML₅₁˜ML₅₃. The sub-conduction line (e.g. SL₁₆) of the third group are coupled to the segments 213a˜213c of the connection lines ML₅₁˜ML₅₃. In this embodiment, the numbers of the sub-conduction lines of the first to third groups are not the same. In other embodiments, the number of sub-conduction lines of one of the first to third groups may be higher than, less than or equal to the number of sub-conduction lines of another of the first to third groups.

Additionally, assuming that the sub-conduction lines SL₂₂˜SL₂₄ connecting to the touch electrode SC₂ are divided into a fourth group, and the sub-conduction lines SL₃₃˜SL₃₅ connecting to the touch electrode SC₃ are divided into a fifth group. In this embodiment, the numbers of the sub-conduction lines of the first, fourth and fifth groups are the same, but the disclosure is not limited thereto. In other embodiments, the number of sub-conduction lines of one of the first, fourth and fifth groups may be higher than, equal to or less than the number of sub-conduction lines of another of the first, fourth and fifth groups

FIG. 6 is a schematic diagram of another exemplary embodiment of the touch element layer 130, according to various aspects of the present disclosure. In this embodiment, the number of sub-conduction lines (SL₄₄) overlapping the touch electrode SC₁ is less than the number of sub-conduction lines (SL₄₅˜SL₄₆) overlapping the touch electrode SC₄. Additionally, the number of sub-conduction lines (SL₄₅˜SL₄₆) overlapping the touch electrode SC₄ is less than the number of sub-conduction lines (SL₄₇˜SL₄₉) overlapping the touch electrode SC₇.

FIG. 8 is a schematic diagram of another exemplary embodiment of the touch element layer 130, according to various aspects of the present disclosure. In this embodiment, the width of the connection line ML₉₁ connecting to the touch electrode SC₁ is different from the width of the connection line ML₉₂ connecting to the touch electrode SC₄. As shown in FIG. 8, the width of the connection line ML₉₁ connecting to the touch electrode SC₁ is the same as the width of the connection line ML₉₄ connecting to the touch electrode SC₂, but the disclosure is not limited thereto. Furthermore, the number of sub-conduction lines (SL₅₀˜SL₅₁) overlapping the touch electrode SC₁ is the same as the number of sub-conduction lines (SL₅₂˜SL₅₃) overlapping the touch electrode SC₄, but the disclosure is not limited thereto. In some embodiments, the number of sub-conduction lines overlapping the touch electrode SC₁ may be higher than or less than the number of sub-conduction lines overlapping the touch electrode SC₄.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display device, comprising:
a first substrate comprising:
a plurality of pixel units arranged in an array;
a first touch electrode corresponding to at least one pixel unit; and
a plurality of first connection lines extended along a first direction and coupled between the first touch electrode and a touch integrated circuit;
a second substrate; and
a display medium disposed between the first and second substrates.

2. The touch display device as claimed in claim 1, wherein the first substrate further comprises:
a plurality of first sub-conduction lines extended along a second direction different from the first direction and coupled to at least two of the first connection lines neighboring each other.

3. The touch display device as claimed in claim 2, further comprising:
a second touch electrode disposed between the first touch electrode and the touch integrated circuit;
a plurality of second connection lines extended along the first direction and coupled between the second touch electrode and the touch integrated circuit; and
a plurality of second sub-conduction lines extended along the second direction and coupled to at least two of the second connection lines neighboring each other,
wherein a first segment of each first connection lines overlaps the first touch electrode, a second segment of each first connection lines overlaps the second touch electrode, the first sub-conduction lines are divided into a first group and a second group, the first sub-conduction lines of the first group are coupled to at least two of the first segments neighboring each other, and the first sub-conduction lines of the second group are coupled to at least two of the second segments neighboring each other.

4. The touch display device as claimed in claim 3, wherein a number of the first sub-conduction lines of the first group is equal to or unequal to a number of the first sub-conduction lines of the second group.

5. The touch display device as claimed in claim 3, wherein a number of the first connection lines is equal to or unequal to a number of the second connection lines.

6. The touch display device as claimed in claim 3, wherein a number of the first sub-conduction lines is equal to or unequal to a number of the second sub-conduction lines.

7. The touch display device as claimed in claim 3, wherein a width of one of the first segments is different from a width of one of the second segments.

8. The touch display device as claimed in claim 3, wherein a width of one of the first connection lines is different from a width of one of the second connection lines.

9. The touch display device as claimed in claim 2, further comprising:
a second touch electrode, wherein a distance between the second touch electrode and the touch integrated circuit is equal to a distance between the first touch electrode and the touch integrated circuit;
a plurality of second connection lines extended along the first direction and coupled between the second touch electrode and the touch integrated circuit; and
a plurality of second sub-conduction lines extended along the second direction and coupled to at least two of the second connection lines neighboring each other,
wherein a width of one of the first connection lines is different from a width of one of the second connection lines.

10. The touch display device as claimed in claim 9, wherein the first connection lines do not overlap the second touch electrode, and the second connection lines do not overlap the first touch electrode.

11. The touch display device as claimed in claim 2, further comprising:
a second touch electrode, wherein a distance between the second touch electrode and the touch integrated circuit is equal to a distance between the first touch electrode and the touch integrated circuit;
a plurality of second connection lines coupled between the second touch electrode and the touch integrated circuit; and
a plurality of second sub-conduction lines extended along the second direction and coupled to at least two of the second connection lines neighboring each other, wherein a number of the second sub-conduction lines is unequal to a number of the first sub-conduction lines.

12. The touch display device as claimed in claim 11, wherein the first connection lines do not overlap the second touch electrode, and the second connection lines do not overlap the first touch electrode.

13. The touch display device as claimed in claim 2, wherein a length of one of the first connection lines is different from a length of another of the first connection lines.

14. The touch display device as claimed in claim 2, wherein the shapes of the first connection lines are not straight.

15. The touch display device as claimed in claim 14, wherein the shapes of the first connection lines are zigzag.

16. The touch display device as claimed in claim 2, wherein in a touch sensing mode, the touch integrated circuit controls a voltage level of the first touch electrode, and in a display mode, the first touch electrode receives a common voltage.

17. The touch display device as claimed in claim 1, wherein the touch integrated circuit provides a first sensing signal to the first touch electrode via a first specific connection line among the first connection lines and provides a second sensing signal to the first touch electrode via a second specific connection line among the first connection lines, and the first sensing signal is different from the second sensing signal.

18. The touch display device as claimed in claim 17, wherein a middle connection line among the first connection lines is disposed between the first specific connection line among the first connection lines and the second specific connection line among the first connection lines.

19. The touch display device as claimed in claim 1, wherein the first substrate further comprises:
a second touch electrode, wherein a distance between the second touch electrode and the touch integrated circuit is equal to a distance between the first touch electrode and the touch integrated circuit;
a plurality of second connection lines coupled between the second touch electrode and the touch integrated circuit;
a third touch electrode, wherein a distance between the third touch electrode and the touch integrated circuit is equal to the distance between the first touch electrode and the touch integrated circuit;
a plurality of third connection lines coupled between the third touch electrode and the touch integrated circuit;
wherein a first distance is between a first specific connection line among the second connection lines and a first specific edge of the second touch electrode, a second distance is between a second specific connection line among the second connection lines and a second specific edge of the second touch electrode, a third distance is between a third specific connection line among the first connection lines and a third specific edge of the first touch electrode, and a fourth distance is between a fourth specific connection line among the third connection lines and a fourth specific edge of the third touch electrode,
wherein the first distance is equal to the third distance, and the second distance is equal to the fourth distance.

20. The touch display device as claimed in claim 19, wherein the first and third specific edges are disposed between the first specific connection line among the second connection lines and the third specific connection line among the first connection lines, and the second and fourth specific edges are disposed between the second specific connection line among the second connection lines and the fourth specific connection line among the third connection lines.
